(19) United States
(12) Patent Application Publication
(10) Pub. No.: US 2006/0200942 A1
(43) Pub. Date: Sep. 14, 2006

(54) Rotary hinge mechanism

(75) Inventor: Nan-Jun Zheng, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FIH CO.,LTD, Shindian City (TW)

(21) Appl. No.: 11/361,618

(22) Filed: Feb. 24, 2006

(30) Foreign Application Priority Data
Mar. 11, 2005 (CN) 200520055759.6

(51) Int. Cl. E05D 7/00

(52) U.S. Cl. 16/221

(57) ABSTRACT

A rotary hinge mechanism (20) includes a connecting element (22), a first hollow fixing element (24), and a second hollow fixing element (26). The connecting element is a hollow cylinder. The connecting element has a first limiting stopper (2224) and a second limiting stopper (2228). The first limiting stopper and the second limiting stopper are respectively formed on two opposite surfaces thereof and circumferentially spaced. The first hollow fixing element has a first abutting block (243) formed on one end surface thereof. The second hollow fixing element has a second abutting block (263) formed on one end surface thereof. The first fixing element is rotatably connected with one end of the connecting element, and the other end of the connecting element is rotatably connected with the second fixing element.

### 1. FIELD OF THE INVENTION

The present invention relates to rotary hinge mechanisms and, particularly, to a rotary hinge mechanism for foldable electronic devices, such as mobile telephones, electronic notebooks, and so on.

### 2. DISCUSSION OF THE RELATED ART

With the development of the technologies of wireless communication and information processing, portable electronic devices, such as mobile telephones and electronic notebooks, are now in widespread use. These electronic devices enable consumers to enjoy the convenience of high technology services, anytime and anywhere. Foldable electronic devices are particularly welcome by consumers for their convenience.

Generally, foldable electronic devices have most of the electronics in one housing, called the body. The other housing, called the cover, normally contains fewer electronic components than the body. Other foldable electronic devices have all the electronics in the body, with the cover containing no electronics. Various types of hinge mechanisms are used to join a body and a cover of a foldable electronic device, so that the cover can unfold up from and fold down upon the body. Also, there are many foldable electronics in which the cover with a display can unfold up from the body, and rotated in a predetermined degree. In this case, it is important to ensure signal transmission and electrical connection between the cover and the body. Nowadays, it is adopted to take two or multi-stranded wiring harness to achieve signal transmission and electrical connection between the display and the main body. In this way, the rotational angle of the cover is limited in 270 degrees. That the rotation angle exceeds this angle will make the wiring harness damaged because of excessive torsion of the wiring harness. In addition, to achieve this rotational angle, it is required to design a complicated rotary hinge mechanism. Also, there are many elements required to achieve this rotational angle, which will increase manufacturing cost and takes up large volume.

What is needed, therefore, is a rotary hinge mechanism which has a relatively simple and small modularized configuration, which can be produced at low cost, and which makes the display rotate in a more angle.

### SUMMARY OF THE INVENTION

In a preferred embodiment, a rotary hinge mechanism includes a connecting element, a first hollow fixing element, and a second hollow fixing element. The connecting element is a hollow cylinder. The connecting element has a first limiting stopper and a second limiting stopper. The first limiting stopper and the second limiting stopper are respectively formed on two opposite surfaces thereof and stagger along circumferential direction. The first hollow fixing element has a first abutting block formed on one end surface thereof The second hollow fixing element has a second abutting block formed on one end surface thereof The first fixing element is rotatably connected with one end of the connecting element, and the other end of the connecting element is rotatably connected with the second fixing element.

Other advantages and novel features will become more apparent from the following detailed description when taken in conjunction with the accompanying drawings.

### BRIEF DESCRIPTION OF THE DRAWINGS

Many aspects of the rotary hinge mechanism can be better understood with reference to the following drawings. The components in the drawings are not necessarily to scale, the emphasis instead being placed upon clearly illustrating the principles of the present rotary hinge mechanism. Moreover, in the drawings, like reference numerals designate corresponding parts throughout the several views.

FIG. 1 is an exploded, isometric view of a rotary hinge mechanism according to a preferred embodiment;

FIG. 2 is similar to FIG. 1, but viewed from another aspect;

FIG. 3 is an assembled view of portion of the rotary hinge mechanism of FIG. 1;

FIG. 4 is similar to FIG. 3, but viewed from another aspect; and

FIG. 5 is an assembled view of the rotary hinge mechanism of FIG. 1.

### DETAILED DESCRIPTION OF PERFERRED EMBODIMENTS

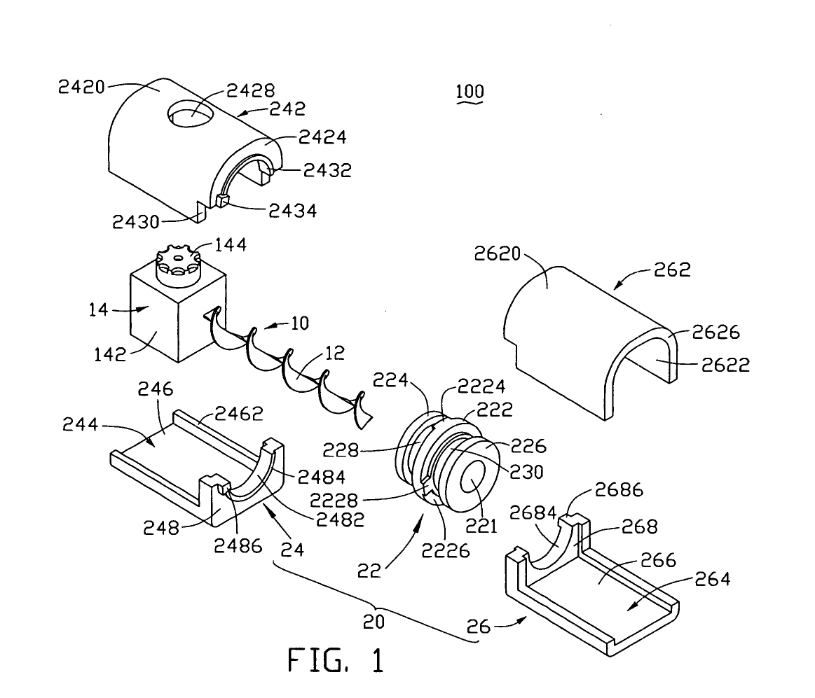

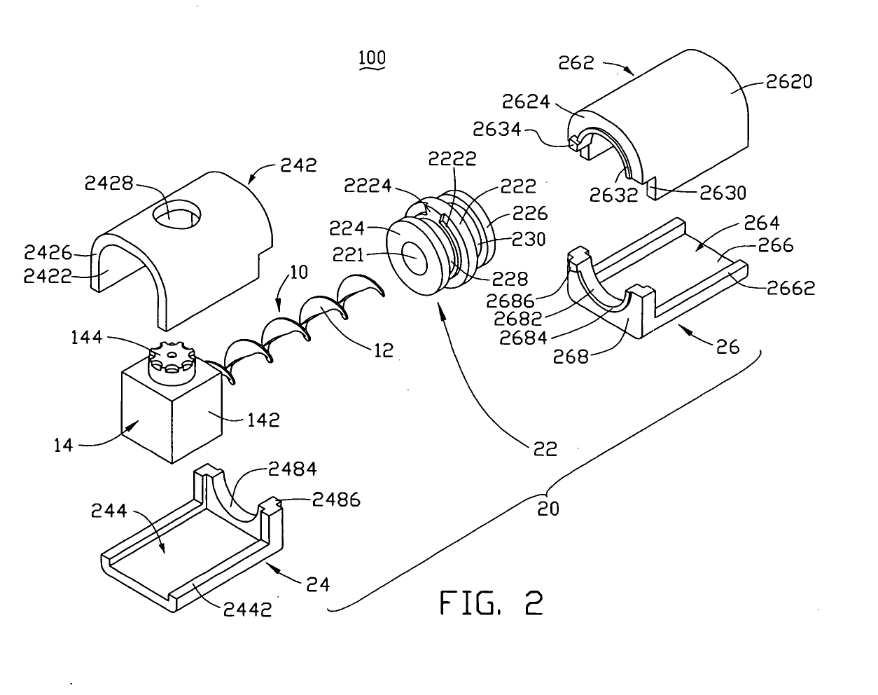

Referring to FIG. 1 and FIG. 2, a rotary hinge module 100 may be used in any of various different kinds of foldable electronic devices with rotatable covers or displays. The rotary hinge module 100 includes an FPC (Flexible Printed Circuit) module 10, and a rotary hinge mechanism 20.

The FPC module 10 includes an FPC board 12, and a camera module 14. The FPC board 12 is helical. One end of the FPC board 12 is electrically connected with the camera module 14 or is electrically connected with electronic components in the rotatable cover or display. The camera module 14 includes a lens holder 142 and a camera lens 144. In this preferred embodiment, the lens holder 142 is hollow cube. Alternatively, the lens holder 142 can be a hollow cylinder. The camera lens 144 is disposed in the lens holder 142, and protrudes out of the lens holder 142. The camera module 14 has an image pick-up sensor (not shown) received in the lens holder 142. The image pick-up sensor is electrically connected with the FPC board 12.

The rotary hinge mechanism 20 includes a connecting element 22, a first fixing element 24, and a second fixing element 26. One end portion of the connecting element 22 is connected with the first fixing element 24, the other end portion of the connecting element 22 is connected with the second fixing element 26. The connecting element 22 can rotate relative to the first fixing element 24 and the second fixing element 26.

The connecting element 22 is a hollow cylinder, and defines a central hole 221 extending therethrough. The connecting element 22 has a first flange 222, a second flange 224 and a third flange 226. The first flange 222, the second flange 224 and the third flange 226 are arranged parallel to each other, and are spaced by a distance. The first flange 222 is located between the second flange 224 and the third flange 226. A first peripheral groove 228 is defined between the first flange 222 and the second flange 224. A second peripheral groove 230 is defined between the second flange 224 and the third flange 226. The first flange 222 has a first annular notch 2222 defined in a first surface thereof facing the second flange 224. A first limiting stopper 2224 is formed on the first annular notch 2222. The first flange 222 has a second annular notch 2226 defined in an opposite second surface thereof facing the third flange 226. A second limiting stopper 2228 is formed on the second annular notch 2226. The first and the second limiting stoppers 2224, 2228 can be arranged stagger along a circumferential direction of the first flange 222. In this embodiment, the first and second limiting stoppers 2224, 2228 are circumferentially spaced with 90 degrees. [bad, you admit you did not give a preferred embodiment]

The first fixing element 24 includes a first arc cover 242, and a first generally L-shaped base 244. The first cover 242 and the first base 244 can joint together to cooperatively define a space therebetween for receiving the camera module 14. The first cover 242 has an outer arc surface 2420 and an inner arc surface 2422. The first cover 242 has a first arc end surface 2424 and a second arc end surface 2426. The first cover 242 defines a round hole 2428 in the center of the outer arc surface 2420 extending through the inner arc surface 2422. The round hole 2428 is configured to expose a portion of the camera lens 144. The first arc cover 242 defines two opposite cutouts 2430 in two distal ends of the first arc end surface 2424. The first arc cover 242 has a first engaging portion 2432 formed on the inner arc surface 2422 and adjacent the first arc end surface 2424. The first engaging portion 2432 protrudes out of the first arc end surface 2424. The first engaging portion 2432 is semi-circular. A first resisting protrusion 2434 protrudes from a sidewall of the first engaging portion 2432, and is adjacent one cutout 2430.

The first base 244 includes a first tabulate body 246 and a first support portion 248 extending vertically upward from one end of the first tabulate body 246. The first tabulate body 246 has two opposite lengthways sidewalls 2462 extending vertically from two opposite sides thereof. The first support portion 248 defines a semi-circular hole 2482 in a distal end thereof. A second engaging portion 2484 is formed around the semi-circular hole 2482, and protrudes out of the first support portion 248. A second resisting protrusion 2486 protrudes from a sidewall of the second engaging portion 2484, and is adjacent the distal end of the support portion 248.

The second fixing element 26 includes a second arc cover 262 and a second generally L-shaped base 264. The second cover 262 and the second base 264 can joint together to cooperatively define a space for receiving the FPC board 12. The second cover 262 has an outer arc surface 2620 and an inner arc surface 2622. The second cover 262 has a first arc end surface 2624 and a second arc end surface 2626. The second arc cover 262 defines two opposite cutouts 2630 in two distal end of the first arc end surface 2624. The second cover 262 has a third engaging portion 2632 formed on the inner arc surface 2622 and adjacent the first arc end surface 2624. The third engaging portion 2632 protrudes out of the first arc end surface 2624. The third engaging portion 2632 is semi-circular. A third resisting protrusion 2634 protrudes from a sidewall of the third engaging portion 2632, and is adjacent one cutout 2630.

The second base 264 includes a second tabulate body 266 and a second support portion 268 extending vertically upward from one end of the second tabulate body 266 that is near to the first base. The second tabulate body 266 has two opposite lengthways sidewalls 2662 extending vertically from two opposite sides thereof. The second support portion 268 defines a semi-circular hole 2682 in a distal end thereof. A fourth engaging portion 2684 is formed on the arc hole 2682, and protrudes from the second support portion 268. A fourth resisting protrusion 2686 protrudes from a sidewall of the first engaging portion 2684, and is adjacent the distal end of the second support portion 268.

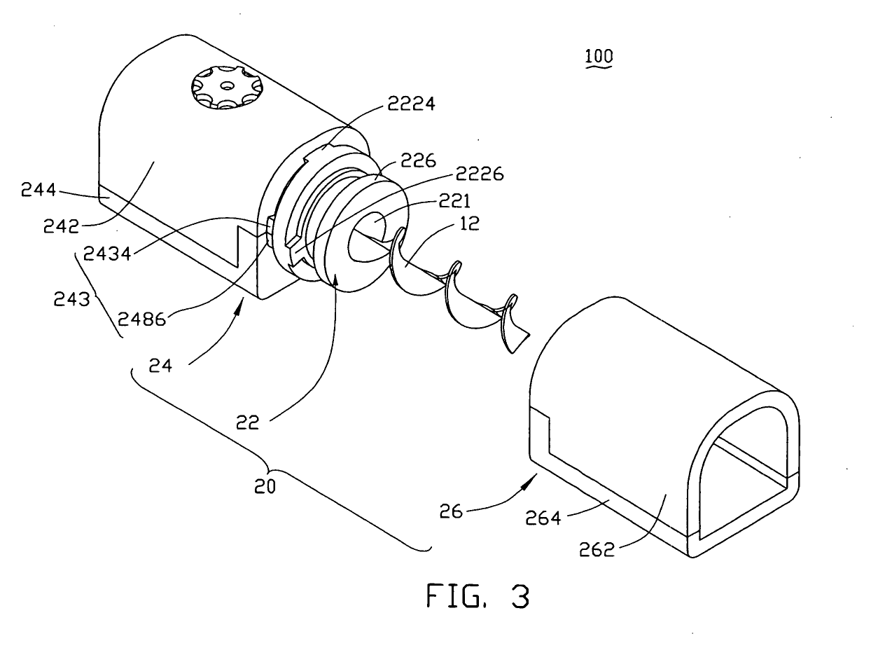

Referring to FIG. 3, in assembly, firstly, the FPC module 10 is disposed on the first tabulate body 246 of the first base 244. The connecting element 22 is disposed on the first support portion 248 of the first base 244, with the second flange 224 extending into the first base 244 and the second engaging portion 2484 of the first base 244 engaging around the peripheral groove 228 of the connecting element 22. Concurrently, the FPC board 12 of the FPC module 10 extends into the central hole 221 of the connecting element 22 from one end thereof, and extends out of the connecting element 22 from the other end thereof. Secondly, the first cover 242 and the first base 244 are jointed together via a glue, with the camera lens 144 of the FPC module 10 exposing out of the round hole 2428 of the first cover 242. Concurrently, the two opposite distal ends of the first base 244 respectively engage in the cutouts 2430 of the first arc cover 242. The first resisting protrusion 2434 of the first cover 242 and the second resisting protrusion 2486 of the first base 244 are jointed together to form a first abutting block 243. The first abutting block 243 can slide in the first annular notch 2222 of the connecting element 22.

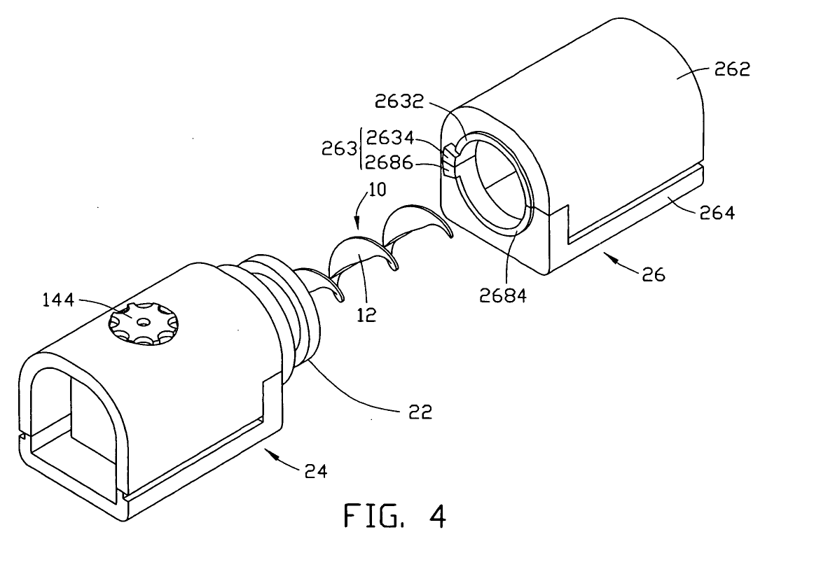

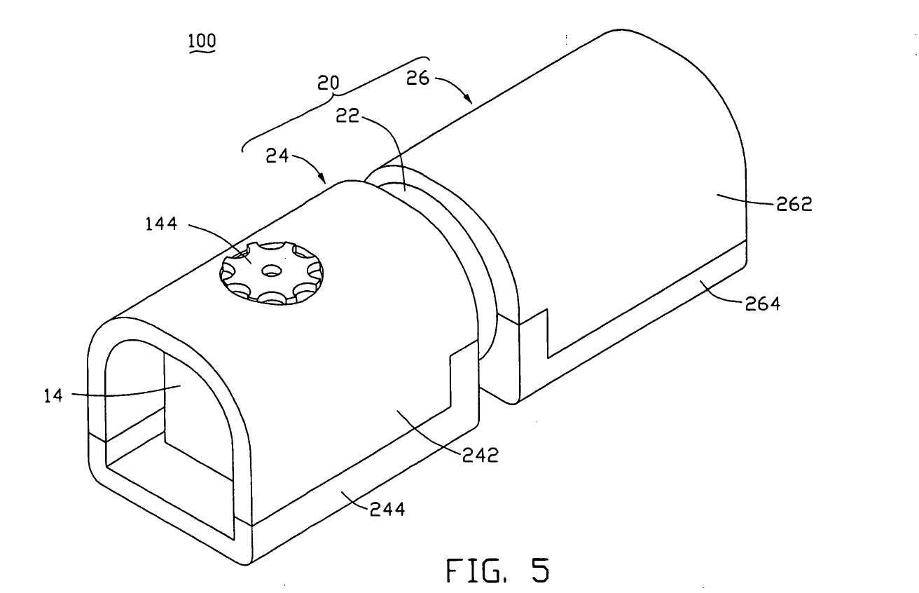

Thirdly, the connecting element 22 is disposed on the second support portion 268 of the second base 264, with the third flange 226 extending into the second base 264 and the fourth engaging portion 2684 of the second base 264 engaging around the peripheral groove 230 of the connecting element 22. Concurrently, the FPC board 12 of the FPC module 10 extends into the second base 246. Fourthly, the second cover 262 and the second base 264 are jointed together via a glue, with the third resisting protrusion 2634 of the second cover 2642 and the fourth resisting protrusion 2686 of the second base 264 are jointed together to form a second abutting block 263 (Referring to FIG. 4). Concurrently, the two opposite distal ends of the second base 264 respectively engage in the cutouts 2630 of the second cover 262. The second abutting block 263 can slide in the second annular notch 2226 of the connecting element 22. The rotary hinge module 100 is thus completely assembled, as shown in FIG. 5.

Referring to FIG. 5, in use, the first fixing element 24 is engaged in a cavity (not shown) of the rotatable cover or display of the foldable electronic device, and the second fixing element 26 is engaged in a main body of the foldable electronic device.

When the rotatable cover or display of the foldable electronic device is rotated between a first position, a second position and a third position (or vice versa) by a user, the first fixing element 24 rotates along with the rotatable cover or display, while the second fixing element 26 remains fixed in the main body of the foldable electronic device. As a result, a relative rotation is produced between the first fixing element 24 and the second fixing element 26. Also, a relative rotation is produced between the first fixing element 24 and the connecting element 22, and the first abutting block 243 of the first fixing element 24 slides in the first annular notch 2222 of the connecting element 22.

When the first fixing element 24 rotates to the second position where the first abutting block 243 of the first fixing element 24 contacts the first limiting stopper 2224 of the connecting element, the user can easily be aware of the second position. Concurrently, if the rotatable cover or display of the foldable electronic device is continuingly rotated, the connecting element 22 rotates along with the first fixing element 24 under a pushing force that the first abutting block 243 exerts on the first limiting stopper 2224 of the limiting element 22. When the first fixing element 24 rotates to a third position where the second limiting stopper 2228 tightly contacts the second abutting block 263 of the second fixing element 26, the connecting element 22 and the first fixing element 24 stops rotating under a stopping force that the second abutting block 263 of the second fixing element 26 exerts on the second limiting stopper 2228 of the connecting element 22. Also, the user can easily be aware of the third position. In this state, the first fixing element 24 and the connecting element 22 can only be rotated in a reverse direction, which can prevent the first fixing element 24 from rotating excessively, and prevent the FPC module 10 from damaged.

In an alternative embodiment, the number of the connecting element 22 can be two or more such that the rotational angle of the first fixing element 24 can be increased. The first limiting stopper 2224 can be disposed on the second flange 224, and the second limiting stopper 2226 can be disposed on the third flange 226. The first flange 222 can be omitted. A peripheral groove is defined between the second flange 224 and the third flange 226.

A main advantage of the embodiment is that the first fixing element 24 can be rotated relative to the second fixing element 26 to a greater angle. Thus, the rotatable cover or display of the foldable electronic device can be rotated relative to the main body to a greater angle. In addition, during the rotational course of the first fixing element 24, the FPC board 12 will not be damaged, instead only the total number of coils of the FPC board 12 change.

In further alternative embodiments, the first cover 242 and the first base 244 can be integrally formed, and the second cover 262 and the second base 264 can be integrally formed. The first fixing element 242 is hollow arc, and defines a first circular hole, and has a first abutting block protruding one end surface thereof adjacent the circular hole. The second fixing element is hollow arc, and defines a second circular hole, and has a second abutting block protruding one end surface thereof adjacent the circular hole.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

I claim:

1. A rotary hinge mechanism, comprising:
a connecting element including a first limiting stopper and a second limiting stopper respectively formed on two opposite surfaces thereof;
a first hollow fixing element rotatably attached to one end portion of the connecting element, and having a first abutting block formed on one end surface thereof for engaging with the first limiting stopper; and
a second hollow fixing element rotatably attached to the other end portion of the connecting element, and having a second abutting block formed on one end surface thereof for engaging with the second limiting stopper.

2. The rotary hinge mechanism as claimed in claim 1, wherein the first fixing element defines a first circular hole receiving the one end portion of the connecting element therein, the first abutting block protrudes from one end surface of the first fixing element adjacent the first circular hole threof, the second fixing element defines a second circular hole receiving the other end portion of the connecting element therein, and the second abutting block protrudes from one end surface of the second fixing element adjacent the second circular hole thereof.

3. The rotary hinge mechanism as claimed in claim 2, wherein the connecting element includes a first flange, a second flange and a third flange arranged parallel to each other and spaced by a distance, the first flange is disposed between the second flange and the third flange, a first peripheral groove is defined between the first flange and the second flange, and a second peripheral groove is defined between the second flange and the third flange.

4. The rotary hinge mechanism as claimed in claim 3, wherein the first flange has a first annular notch defined in a first surface thereof facing the second flange, and the first limiting stopper is formed on the first surface.

5. The rotary hinge mechanism as claimed in claim 4, wherein the first fixing element engages around the first peripheral groove of the connecting element, and the first abutting block of the first element is slidable in the first annular notch.

6. The rotary hinge mechanism as claimed in claim 3, wherein the first flange has a second annular notch defined in a second surface thereof facing the third flange, and the second limiting stopper is formed on the second surface.

7. The rotary hinge mechanism as claimed in claim 6, wherein the second fixing element engages around the second peripheral groove of the connecting element, and the second abutting block of the second element is slidable in the second annular notch.

8. The rotary hinge mechanism as claimed in claim 2, wherein at least one of the first fixing element and the second fixing element includes a cover and a base, and the cover and the cover cooperatively define a space when jointed together.

9. The rotary hinge mechanism as claimed in claim 8, wherein the cover has two opposite notches defined in two distal ends of one end surface thereof.

10. The rotary hinge mechanism as claimed in claim 9, wherein the cover has a semi-circular engaging portion formed on an inner surface thereof and adjacent one end surface thereof, a resisting protrusion formed on the engaging portion and adjacent one notch.

11. The rotary hinge mechanism as claimed in claim 10, wherein the base includes a tabulate body and a support portion perpendicularly extending form one distal end of the tabulate body.

12. The rotary hinge mechanism as claimed in claim 11, wherein the support portion defines a semi-circular hole, and a semi-circular engaging portion formed on an inner surface thereof and adjacent one end surface thereof, a resisting protrusion formed on the engaging portion of the supportion portion and adjacent a distal end of the support portion, the resisting protrusion of the cover and the resisting protrusion of the base cooperatively form one of the first and second abutting blocks.

13. The rotary hinge mechanism as claimed in claim 1, wherein the first and second limiting stopper are circumferentially spaced.

14. A rotary hinge module, comprising:
a connecting element being a hollow cylinder including a first limiting stopper and a second limiting stopper respectively formed on two opposite surfaces thereof;
a first hollow fixing element rotatably attached to one end portion of the connecting element, and having a first abutting block for engaging with the first limiting stopper;
a second hollow fixing element rotatably attached to the other end portion of the connecting element, and having a second abutting block for engaging with the second limiting stopper; and
a flexible printed circuit board module comprising a helical flexible printed circuit board, the helical flexible printed circuit board orderly extending through the connecting element;

15. The rotary hinge module as claimed in claim 14, wherein the flexible printed circuit board module further includes a camera module received in the first fixing element, and the flexible printed circuit board is electrically connected with the camera module.

16. The rotary hinge module as claimed in claim 14, wherein when the first fixing element is rotatable between a first position and a second position, the first fixing element is rotatable relative to the connecting element, and the second fixing element, and when the first fixing element is rotatable between a second position and a third position, the first fixing element is rotatable along with the connecting element, and relative to the second fixing element.

17. The hinge assembly as claimed in claim 16, wherein when the first fixing element is in the second position, the first abutting block abuts the first limiting stopper, and when the first fixing element is in the third position, the second limiting stopper abuts the second abutting block.

18. A rotary hinge mechanism comprising:
a first fixing element;
a connecting element having opposite two connecting ends, one of the connecting ends being rotatably connected with the first fixing element, a first stopping structure being formed between the first fixing element and the connecting element so that when the first fixing element rotates relative to the connecting element to a first predetermined angular position, the fixing element drives the connecting element to rotate therewith by the first stopping structure; and
a second fixing element rotatably connected with the other of the connecting ends of the connecting element, a second stopping structure being formed between the connecting element and the second fixing element so that when the connecting element is rotated relative to the second element to a second predetermined angular position, the connecting element is stopped from further rotating by the second stopping structure.

19. The rotary hinge module of claim 18, wherein at least one of the first and second stopping structures comprises a limiting stopper formed on the connecting element, and an abutting block formed a corresponding one of the first and second fixing elements for contacting the limiting stopper.

20. The rotary hinge module of claim 19, wherein the connecting member includes a peripheral flange, the limiting stopper is formed on the flange, and the abutting block moves relatively along the flange into contact with the limiting member when said corresponding one of the first and second fixing elements rotates relative to the connecting element.
